(19) United States
(12) Patent Application Publication
(10) Pub. No.: US 2026/0349708 A1
(43) Pub. Date: Nov. 5, 2026

(54) DEPLOYMENT DEPENDENCY RESOLUTION FOR CODE MODULE CONFIGURATION AND ACTIVATION WITH ZERO DOWNTIME

(71) Applicant: International Business Machines Corporation, Armonk, NY (US)

(72) Inventors: Uwe Karl Hansmann, Tuebingen (DE); Stefan Usenbinz, Böblingen (DE); Ralf Schaufler, Weil im Schoenbuch (DE); Martin Tröster, Renningen (DE)

(21) Appl. No.: 18/583,940

(22) Filed: Feb. 22, 2024

(51) Int. Cl. G06F 8/656; G06F 8/30

(52) U.S. Cl. CPC G06F 8/656; G06F 8/31

(57) ABSTRACT

A computer-implemented method includes receiving a code module update at an update scheduler. The code module update including at least one updated code module and a set of constraints. The method determines at least one viable update schedule for a zero downtime software system based on the received set of constraints and a default update schedule. The at least one viable update schedule includes an update sequence of code modules, configuration sequence of code modules, and activation sequence of code modules. The method generates a script configured to apply a selected viable update schedule of the at least one viable update schedules using script generation software and updates the code module by applying the script to the zero downtime software system.

### BACKGROUND

The present invention generally relates to updating code modules within a software package, and more specifically, to maintaining proper dependencies while activating and configuring code modules in a zero downtime computer system.

Modern computer systems have shifted from traditional software, written as large individual blocks of code to software architectures made up of smaller code modules, each of which performs specific tasks. The code modules are dependent on each other such that certain code modules utilize and/or rely on other modules operating. In such cases scheduling an order for activating and configuring updated code modules without downtime of the overall system requires intricate knowledge of all the dependencies in the system and is typically achieved using an update scheduler written by a specialist with knowledge of all the dependencies between each code module. Such schedulers are typically static and any code update requires a new scheduler to be written.

### SUMMARY

Embodiments of the present invention are directed to a computer-implemented method for scheduling a code module update and activation sequence in a zero downtime environment. A non-limiting example of the computer-implemented method includes receiving a code module update at an update scheduler. The code module update including at least one updated code module and a set of constraints. The method determines at least one viable update schedule for a zero downtime software system based on the received set of constraints and a default update schedule. The at least one viable update schedule includes an update sequence of code modules, configuration sequence of code modules, and activation sequence of code modules. The method generates a script configured to apply a selected viable update schedule of the at least one viable update schedules using script generation software and updates the code module by applying the script to the zero downtime software system.

Embodiments of the present invention are further directed to systems and computer program products for the implementing same. The computer program products comprising a computer readable storage medium having program instructions embodied therewith. The program instructions are executable by a processor to cause the processor to perform the computer implemented method.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts one exemplary cloud computing system configured to implement the system and method according to one embodiment;

FIG. 2 is a visual representation of an dependency of code modules within a computer system;

FIG. 3 depicts a table describing the dependencies of FIG. 2; and

FIG. 4 depicts a process for implementing an activation and configuration schedule for updating code modules using the update scheduler 150 of FIG. 1.

The diagrams depicted herein are illustrative. There can be many variations to the diagram or the operations described therein without departing from the spirit of the invention. For instance, the actions can be performed in a differing order or actions can be added, deleted or modified. In further examples, the number of code modules can be substantially larger and the dependencies between the code modules may be more or less complex. Also, the term “coupled” and variations thereof describes having a communications path between two elements and does not imply a direct connection between the elements with no intervening elements/connections between them. The communication pathways may, in some examples, include software calls. All of these variations are considered a part of the specification.

In the accompanying figures and following detailed description of the disclosed embodiments, the various elements illustrated in the figures are provided with two or three digit reference numbers. With minor exceptions, the leftmost digit(s) of each reference number correspond to the figure in which its element is first illustrated.

### DETAILED DESCRIPTION

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e. one, two, three, four, etc. The terms “a plurality” may be understood to include any integer number greater than or equal to two, i.e. two, three, four, five, etc. The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

Computing environment 100 contains an example of an environment for the execution of at least some of the computer code involved in performing the inventive methods, such as providing a configuration schedule and an activation schedule for code modules in an update scheduler at block 150. In addition to block 150, computing environment 100 includes, for example, computer 101, wide area network (WAN) 102, end user device (EUD) 103, remote server 104, public Cloud 105, and private Cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI), device set 123, storage 124, and Internet of Things (IoT) sensor set 125), and network module 115. Remote server 104 includes remote database 132. Public Cloud 105 includes gateway 130, Cloud orchestration module 131, host physical machine set 142, virtual machine set 143, and container set 144.

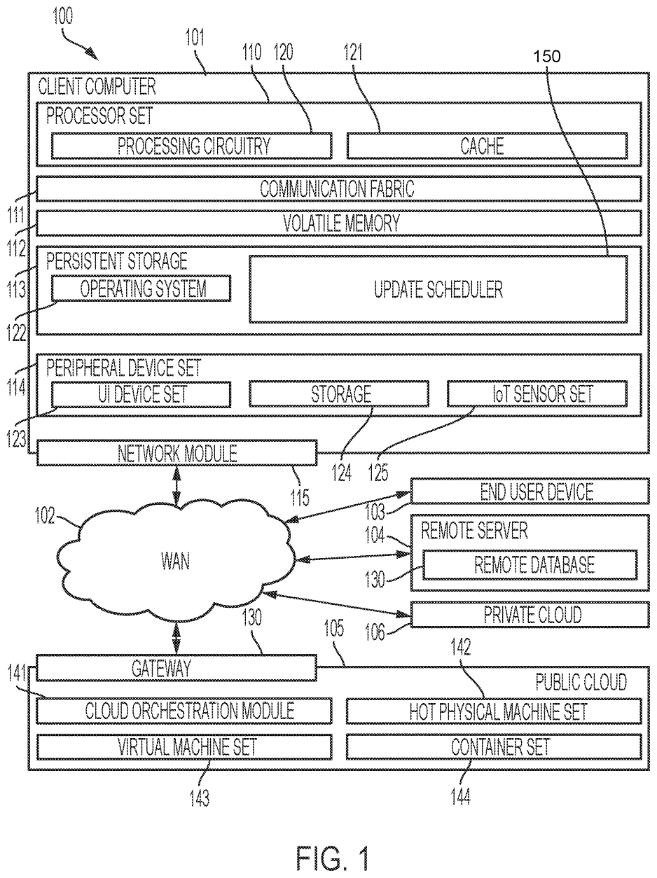

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 132. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a Cloud, even though it is not shown in a Cloud in FIG. 1. On the other hand, computer 101 is not required to be in a Cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collects and store helpful and useful data for use by other computers, such as computer 101. For example, in a hypothetical case where computer 101 is designed and programmed to provide a recommendation based on historical data, then this historical data may be provided to computer 101 from remote database 132 of remote server 104.

PUBLIC CLOUD 105 is any computer system available for use by multiple entities that provides on-demand availability of computer system resources and/or other computer capabilities, especially data storage (Cloud storage) and computing power, without direct active management by the user. Cloud computing typically leverages sharing of resources to achieve coherence and economies of scale. The direct and active management of the computing resources of public Cloud 105 is performed by the computer hardware and/or software of Cloud orchestration module 131. The computing resources provided by public Cloud 105 are typically implemented by virtual computing environments that run on various computers making up the computers of host physical machine set 142, which is the universe of physical computers in and/or available to public Cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 131 manages the transfer and storage of images, deploys new instantiations of VCEs and manages active instantiations of VCE deployments. Gateway 130 is the collection of computer software, hardware, and firmware that allows public Cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public Cloud 105, except that the computing resources are only available for use by a single enterprise. While private Cloud 106 is depicted as being in communication with WAN 102, in other embodiments a private Cloud may be disconnected from the internet entirely and only accessible through a local/private network. A hybrid Cloud is a composition of multiple Clouds of different types (for example, private, community or public Cloud types), often respectively implemented by different vendors. Each of the multiple Clouds remains a separate and discrete entity, but the larger hybrid Cloud architecture is bound together by standardized or proprietary technology that enables orchestration, management, and/or data/application portability between the multiple constituent Clouds. In this embodiment, public Cloud 105 and private Cloud 106 are both part of a larger hybrid Cloud.

One or more embodiments described herein can utilize machine learning techniques to perform prediction and or classification tasks, for example. In one or more embodiments, machine learning functionality can be implemented using an artificial neural network (ANN) having the capability to be trained to perform a function. In machine learning and cognitive science, ANNs are a family of statistical learning models inspired by the biological neural networks of animals, and in particular the brain. ANNs can be used to estimate or approximate systems and functions that depend on a large number of inputs. Convolutional neural networks (CNN) are a class of deep, feed-forward ANNs that are particularly useful at tasks such as, but not limited to analyzing visual imagery and natural language processing (NLP). Recurrent neural networks (RNN) are another class of deep, feed-forward ANNs and are particularly useful at tasks such as, but not limited to, unsegmented connected handwriting recognition and speech recognition. Other types of neural networks are also known and can be used in accordance with one or more embodiments described herein.

ANNs can be embodied as so-called “neuromorphic” systems of interconnected processor elements that act as simulated “neurons” and exchange “messages” between each other in the form of electronic signals. Similar to the so-called “plasticity” of synaptic neurotransmitter connections that carry messages between biological neurons, the connections in ANNs that carry electronic messages between simulated neurons are provided with numeric weights that correspond to the strength or weakness of a given connection. The weights can be adjusted and tuned based on experience, making ANNs adaptive to inputs and capable of learning. For example, an ANN for handwriting recognition is defined by a set of input neurons that can be activated by the pixels of an input image. After being weighted and transformed by a function determined by the network's designer, the activation of these input neurons are then passed to other downstream neurons, which are often referred to as “hidden” neurons. This process is repeated until an output neuron is activated. The activated output neuron determines which character was input.

A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Turning now to an overview of technologies that are more specifically relevant to aspects of the invention, traditional software applications were constructed of large blocks of code configured to perform all, or most, of a given task. As computer technology has advanced, the trend in software architecture has moved toward software designed as multiple small chunks of code, referred to herein as code modules, with each code module being configured to perform a specific task. The code modules are dependent on each other in order for the software to function as designed.

In typical implementations, individual code modules are updated by taking the software offline (e.g., stopping operation of the software), providing updated code modules, and re-initializing all of the modules to restart the software. In examples requiring minimal downtime, this can be achieved utilizing redundant systems and starting a new instance of the software on a redundant system before the update. However, even using redundant systems results in a certain amount of downtime as the process switches over to the redundant system.

Certain modern implementations, however, benefit from a zero downtime environment. As used herein “zero downtime environment” refers to a software system designed and able to run non-stop and to implement software updates without a pause. In zero downtime software environments, the order in which the updated code modules are activated and the order in which the updated code modules are configured is important due to the dependencies between code modules and incorrect activation and/or configuration orders can result in sub-optimal operation or temporary downtime.

The update scheduler 150 provided herein establishes a system and framework for providing a declarative and agent-less approach to configuration and activation order requirements that accounts for dependencies and orders within complex software systems with zero downtime requirements. The update scheduler 150 allows a developer to specify activation and order requirements of a given code module in declarative way, without requiring the developer of a given code module to have full knowledge of the entire software architecture and without requiring a full schedule to be written for each update. The update scheduler 150 includes code that generates a corresponding script during a build process or at the point the code is applied to the system, with the script defining an update, activation and configuration order for each code module being updated. In at least one example, the update, activation, and configuration schedules include one or more differences in order of operations.

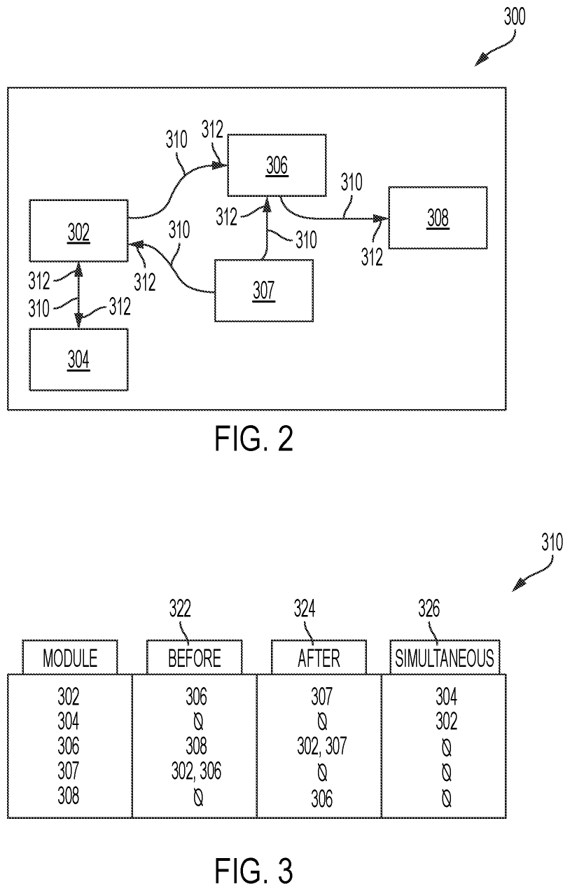

With continued reference to the software environment of FIG. 1, FIG. 2 illustrates a highly simplified software architecture 300 including five code modules 302, 304, 306, 307, 308. It is appreciated that practical implementations of the software architecture 300 will include substantially larger numbers of code modules, and the simplified illustration is provided for explanatory effect. In some practical examples, the software architecture can include between 100 and 1000 code modules.

Each of the five code modules 302, 304, 306, 307, 308 is dependent on one or more other of the five code modules 302, 304, 306, 307, 308 as indicated by dependency couplings 310, with the direction of arrows within the dependency coupling indicating what form of dependency is present. In the example illustration of FIG. 2, the dependency couplings 310 represent activation interferences. Similar mapping can be done illustrating configuration dependencies. In some examples, such as the example illustrated in FIG. 2, the activation and the configuration dependencies between each of the five code modules 302, 304, 306, 307, 308 and each other of the five code modules 302, 304, 306, 307, 308 can be entirely distinct from and/or include variations between the activation and the configuration dependencies.

Each coupling 310 includes one or two arrowheads 312, with the position and orientation of the arrowheads 312 indicating a directionality of the dependency represented by the coupling 310. By way of example, the coupling 310 connecting code modules 302 and 304 includes an arrowhead 312 on each end, representing a requirement that the code modules 302, 304 be activated and configured simultaneously. Conversely, the coupling 310 interconnecting code modules 302 and 306 includes a single arrowhead directed toward code module 306 indicating that code module 302 should be activated and configured before code module 306 during an update sequence.

In some applications, the dependencies represented via the couplings 310 in FIG. 2 are described within the update scheduler 150 using a lookup table 320, illustrated in FIG. 3. The example lookup table 320 includes a row for each code module 302, 304, 306, 307, 308, with a first column 322 for each code module 302, 304, 306, 307, 308 that the code module 302, 304, 306, 307, 308 of that row should be activated before, a second column 324 for each code module 302, 304, 306, 307, 308 defining which code modules 302, 304, 306, 307, 308 the code module of that row should be activated and configured after, and a third column 326 defining which code modules 302, 304, 306, 307, 308 the code module 302, 304, 306, 307, 308 of that row should be activated and configured with simultaneously.

The dependencies described in FIGS. 2 and 3 are stored in a database, with the database being accessible by the update scheduler 150. In some examples, the database can be stored in the same memory and/or computer system as the update scheduler 150. In alternate examples, the database can be remote from the update scheduler 150, and can communicate with the update scheduler via conventional computer communication protocols.

As illustrated in FIG. 2, and defined at the table 320 of FIG. 3, some code modules 302, 304, 306, 307, 308 have no dependency with some other code modules 302, 304, 306, 307, 308, as they have no direct interaction. By way of example, there is no dependency between code modules 307 and 308, or between code module 304 and code modules 306, 307 and 308. However, due to the interconnectedness of the one or more code modules 302, 304, 306, 307, 308, even non-dependent code modules (e.g., modules 304 and 308) may have scheduling and order requirements that should be followed. In the traditional software systems, the coder responsible for creating the update schedule maintained and tracked all of these dependencies and individuals working on specific code modules 302, 304, 306, 307, 308 would submit updates to the scheduler coder, who would then create an appropriate schedule.

The dependencies and relationships illustrated in FIGS. 2 and 3 are simplified for ease of explanation, and practical implementations can include substantially more code modules and more complex dependencies between code modules.

Similar tables and representations of those shown in FIGS. 2 and 3 can independently represent the configuration, update and activation dependencies of each code module in any given application. It is appreciated herein that the configuration, update and activation schedules are decoupled from each other, and an identified update schedule should not be applied as a configuration schedule due to the potential differences from the decoupling. As such, the update scheduler 150 generates independent update, configuration and activation schedules based on the corresponding dependencies.

The update scheduler 150 replaces the coder responsible for creating the scheduling script with a process that allows a coder for a specific code module 302, 304, 306, 307, 308 to specify the dependencies of a given code update at the time the code change is developed without requiring the coder of that update to consider all dependencies that are indirectly affected. The dependencies are described as constraints imposed on the specific code module 302, 304, 306, 307, 308 that is being updated. By way of example the following types of constraints may exist between two example code modules A, B (e.g., any of code modules 302, 304, 306, 307, 308):
ACTIVATE_BEFORE (A, B): code module A needs to be activated first before the upgrade of code module B can start;
ACTIVATE_AFTER (B, A): code module B needs to be activated after the activation of code module A;
ACTIVATE_TOGETHER (A, B): code module A and code module B have a mutual dependency and need to be upgraded at the same time. During this upgrade it is ensured that there is no communication between code modules A and B;
CONFIG_BEFORE (A, B): code module A needs to be configured first before the configuration of code module B can start;
CONFIG_AFTER (A, B): code module B needs to be configured before the configuration of code module A can start;
FORCE_REBOOT_ON_ACTIVATE (A): code module A needs to be rebooted before code module A can be activated; and
FORCE_REBOOT_ON_DEACTIVATE (A): code module A needs to be rebooted before code module 302 can be de-activated.

The enumerated constraints are provided for explanation, and the example list is not limiting. Practical implementations of the update scheduler 150 can accommodate some or all of the enumerated constraints. Furthermore, some practical implementations can accommodate additional constraints beyond those expressly enumerated herein.

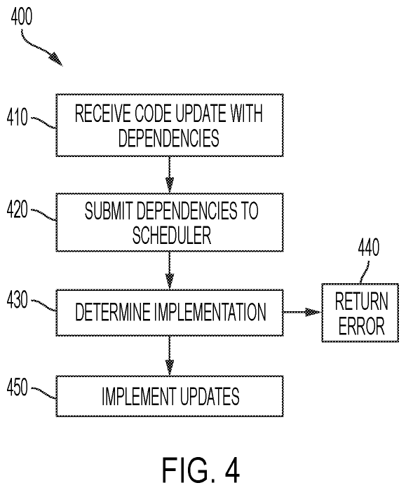

With continued reference to FIGS. 1-3, FIG. 4 illustrates a method 400 by which the update scheduler 150 schedules an implementation of an update to one or more code modules 302, 304, 306, 307, 308 automatically, without requiring a dedicate person to code a full update schedule. Initially a coder (e.g., a programmer or team of programmers) creates an update to one of more code modules and submits the update to the update scheduler 150. In the process of submitting the update, the coder identifies one or more dependencies of the particular code modules 302, 304, 306, 307, 308 that are being updated using one or more constraints including the example constraints and/or other unlisted constraints. The computer system 100 receives the code update and the constraints in a “Receive Code Update With Dependencies” step 410.

After receiving the code updates, the dependencies are submitted to the update scheduler 150 in a “Submit Dependencies to Scheduler” step 420. The update scheduler 150 uses the table 320, stored in the computer system 10, to identify any upstream or downstream dependencies that are impacted by the submitted constraints and modifies an existing default update schedule to accommodate the impacted dependencies. In examples where the submitted constraints contradict existing dependencies on other code modules, and there is no update order that can circumvent the conflict (e.g., a constraint requires activation of code module 304 to occur before activation of code module 306 and an existing constraint requires activation of code module 306 to occur before activation of code module 304), the method 400 returns an error at “Return Error” step 440. The error can, in some examples terminate operation of the scheduling process.

In other examples, the error can provide a prompt or other interface for the coder to update the constraints assigned. In such examples, the method 400 is paused rather than being terminated, and any received constraint updates are reprocessed at the “Determine Implementation” step 430.

When a possible update order is determined, the update scheduler 150 causes the code modules 302, 304, 306, 307, 308 to be added or updated in an “Implement Updates” step 450.

In the event that multiple possible implementations are identified, the update scheduler 150 can, in some examples, identify an optimal implementation of the determined possible implementations. In one example, the optimal implementation is the implementation including the least number of adjusted constraints. By way of example, when two code modules 302, 304 may be updated in either order, but updating one code module 302 first results in less modifications to the upstream and/or downstream constraints defined in the default scheduler, the optimum implementation is the implementation that updates code module 302 first.

In another example, the optimum implementation is an implementation with the least number of sequential operations (alternately expressed as having the most number simultaneous operations). In this example, the optimum implementation is the implementation able to be completed in the shortest amount of real time.

In yet another alternative, as soon as the update scheduler 150 identifies a viable update schedule, the update scheduler 150 ceases the determine implementation step 430 and begins implementing the identified update schedule at the implement updates step 450.

With reference to all of FIGS. 1-4, in one example, the available constraints that are understood by the update scheduler 150 can be stored in a database, the dependencies being stored as tuples in the form of <Dependency_type>-<code_change_component_A>-<code_change_component_b>.

In one particular example a distributed version control system, such as git, is used as the source code repository:

| Dependency_type | Code_change_component_A | Code_change_component_B |
|---|---|---|
| ACTIVATE_BEFORE | https://github.com/ibm/compA/ | https://github.com/ibm/compB/ |
| | commit/150831f | commit/654aef |
| ACTIVATE_TOGETHER | https://github.com/ibm/compC/ | https://github.com/ibm/compE/ |
| | commit/12345 | commit/9aef45 |

During the build process for a code update for the various components, the dependency database is used to extract all tuples which contain code commits which are also part of the update. For example the update for code module A includes three git commits in https://github.com/ibm/compA with commit IDs 4345566, 150831f, 6ea34565, the first tuple in the table above would be extracted since it contains 150831f.

The extracted tuples are used as input for a Boolean satisfiability problem (SAT) solver such as clasp. The SAT solver either detects that the dependencies cannot be satisfied (e.g. due to cyclic dependencies) or it finds a solution. In this case the “solution” is a specific order in which components need to be upgraded. From this information a script is automatically generated using any available script generation software, and the script executes the sequence on the system.

As an example the following dependencies exist, and are submitted by the coder alongside the update:
ACTIVATE_BEFORE(A, B)
ACTIVATE_BEFORE(A, D)
ACTIVATE_BEFORE(D, C)
   The SAT solver calculates a solution and the generated script is
Sequence {
Upgrade A
Parallel {
Upgrade B
Upgrade D}
Upgrade C}

The particular example and the accompanying pseudocode is provided for explanatory purposes only, and does not limit practical implementations of the system and method described herein.

Certain dependencies are more difficult for SAT solvers to handle than others. By way of example, activating two code modules 302, 304 simultaneously is semantically identically to instructing the SAT solver to solve each code module 302, 304 before the other. This is referred to as being a cyclic dependency. Thus an ACTIVATE_TOGETHER dependency type has a special handling by the SAT solver. The intended action of such a dependency is that both A and B will be upgraded at the same time. However the upgrade process of A and B takes a certain amount of time. During this time conditions may occur where the dependency would be violated. By way of example, if A completes its upgrade first the ACTIVTATE_BEFORE (B, A) portion would be violated. In the system this violation does not matter as long A and B don't communicate to each other during this time frame. Thus, the upgrade is made pseudo-atomic by first disabling communication between A and B, performing the upgrade of A and B and then enabling the communication again.

To use the SAT solver any ACTIVATE_TOGETHER (A, B) dependency triggers the creation of a new pseudo component XAB which represents A and B. Any other dependency to A or B is replaced with a dependency to XAB. This eliminates the cyclic dependency which the SAT solver would fail on. After SAT resolution XAB is expanded again to A and B with surrounding enable and disable communication instructions.
ACTIVATE_TOGETHER(A, B)
ACTIVATE_BEFORE(A, C)
ACTIVATE_BEFORE(B, D)
   The transformed dependencies for the SAT solver are
ACTIVATE_BEFORE(XAB, C)
ACTIVATE_BEFORE(XAB, D)
   After SAT solving the generated script is
Sequence {
Upgrade XAB
Parallel {
Upgrade C
Upgrade D}
   And after expanding XAB the script is
Sequence {
Disable_communication(A, B)
Parallel {
Upgrade A
Upgrade B}
Enable_communication(A, B)
Parallel {
Upgrade C
Upgrade D}

The particular example and the accompanying pseudocode is provided for explanatory purposes only, and does not limit practical implementations of the system and method described herein.

While illustrated and described above within the context of cloud computing systems, it is appreciated that the present invention may be a system, a method, and/or a computer program product at any possible technical detail level of integration. The computer program product may include a computer readable storage medium (or media) having computer readable program instructions thereon for causing a processor to carry out aspects of the present invention. Further, the present invention may be utilized within any computer system architecture and is not limited to cloud environments.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method comprising:
receiving a code module update at an update scheduler, the code module update including at least one updated code module and a set of constraints;
determining at least one viable update schedule for a zero downtime software system based on the received set of constraints and a default update schedule, wherein the at least one viable update schedule includes an update sequence of code modules, configuration sequence of code modules, and activation sequence of code modules;
generating a script configured to apply a selected viable update schedule of the at least one viable update schedules using script generation software; and
updating the code module by applying the script to the zero downtime software system.

2. The computer-implemented method of claim 1, wherein determining at least one viable update schedule comprises determining a plurality of viable update schedules and selecting an optimum update schedule of the viable update schedules to be the selected viable update schedule.

3. The computer-implemented method of claim 2, wherein the optimum update schedule is an update schedule expected to require a least amount of real time of the determined at least one viable update schedules.

4. The computer-implemented method of claim 2, wherein the optimum update schedule is an update schedule requiring a least amount of deviation from the default update schedule.

5. The computer-implemented method of claim 1, wherein determining at least one viable update schedule for the zero downtime software system comprises determining exactly one viable update schedule for the zero downtime software.

6. The computer-implemented method of claim 1, further comprising notifying a user in response to no viable update schedule for the zero downtime software system being possible.

7. The computer-implemented method of claim 6, further notifying the user includes providing the user a prompt requesting modified update constraints.

8. The computer-implemented method of claim 1, wherein updating the code module by applying the script to the zero downtime software system comprises maintaining operation of the software system for an entire application of the script application.

9. A non-transitory computer readable medium comprising:
a memory storing instructions for updating a code module in a zero downtime software system, the instructions including code configured to cause the zero downtime software system to respond receiving a code module update at an update scheduler, the code module update including at least one updated code module and a set of constraints by determining at least one viable update schedule for a zero downtime software system based on the received set of constraints and a default update schedule, generating a script configured to apply a selected viable update schedule of the at least one viable update schedules using script generation software, and updating the code module by applying the script to the zero downtime software system; and
wherein the at least one viable update schedule includes an update sequence of code modules, configuration sequence of code modules, and activation sequence of code modules.

10. The non-transitory computer readable medium of claim 9, wherein determining at least one viable update schedule comprises determining a plurality of viable update schedules and selecting an optimum update schedule of the viable update schedules to be the selected viable update schedule.

11. The non-transitory computer readable medium of claim 10, wherein the optimum update schedule is an update schedule expected to require a least amount of real time of the determined at least one viable update schedules.

12. The non-transitory computer readable medium of claim 10, wherein the optimum update schedule is an update schedule requiring a least amount of deviation from the default update schedule.

13. The non-transitory computer readable medium of claim 9, wherein determining at least one viable update schedule for the zero downtime software system comprises determining exactly one viable update schedule for the zero downtime software.

14. The non-transitory computer readable medium of claim 9, further comprising notifying a user in response to no viable update schedule for the zero downtime software system being possible.

15. The non-transitory computer readable medium of claim 14, further notifying the user includes providing the user a prompt requesting modified update constraints.

16. The non-transitory computer readable medium of claim 9, wherein updating the code module by applying the script to the zero downtime software system comprises maintaining operation of the software system for an entire application of the script.

17. A computer system comprising:
a processor and a non-transitory memory, the non-transitory memory storing instructions for causing the computer system to respond to receiving a code module update at an update scheduler, the code module update including at least one updated code module and a set of constraints by determining at least one viable update schedule for a zero downtime software system based on the received set of constraints and a default update schedule, generating a script configured to apply a selected viable update schedule of the at least one viable update schedules using script generation software and updating the code module by applying the script to the zero downtime software system; and
wherein the at least one viable update schedule includes an update sequence of code modules, configuration sequence of code modules, and activation sequence of code modules.

18. The computer system of claim 17, wherein determining at least one viable update schedule for the zero downtime software system comprises determining exactly one viable update schedule for the zero downtime software.

19. The computer system of claim 17, wherein the non-transitory memory further stores instructions configured to cause the computer system to respond to no viable update schedule for the zero downtime software system being possible by notifying a user.

20. The computer system of claim 17, wherein updating the code module by applying the script to the zero downtime software system comprises maintaining operation of the software system for an entire application of the script.
